(19) United States
(12) Patent Application Publication
(10) Pub. No.: US 2008/0296434 A1
(43) Pub. Date: Dec. 4, 2008

(54) Parachute-Landing Device for Whole Airplane

(76) Inventor: Songshan Yan, Anhui (CN)

Correspondence Address: GLOBAL IP SERVICES, 7285 W. Eagle Court, Winton, CA, 95388, US

(21) Appl. No.: 12/092,266

(22) PCT Filed: Dec. 31, 2006
(86) PCT No.: PCT/CN06/03825

§ 371 Date: Apr. 30, 2008

(30) Foreign Application Priority Data
Jan. 5, 2006 (CN) 200610037618.0

(51) Int. Cl. B64D 17/80

(52) U.S. Cl. 244/139

(57) ABSTRACT

A parachute-landing device for whole airplane, comprising at least one parachute compartment (4) on the airplane (1), which has a cover (5) who can be controlled to open, and in which there set a parachute (2) with a guiding parachute (3) which is set in the space formed by the parachute compartment (4) and its cover (5), and the end of the sling (21) of which is fixed relatively to the parachute compartment (4), characterized in that a wind-guiding pipe (11) is set on the windward side of the parachute compartment (4), the front end and the rear end of the wind-guiding pipe (11) are respectively the air inlet (12) and the air outlet (13), and the air inlet (12) will be covered by the cover (5) of the parachute compartment (4) when the cover (5) is closed, while the air outlet (13) is in the parachute compartment (4) and the guiding parachute (3) of the parachute (2) covers the air outlet (13). The parachute of the present invention can be opened without power. It not only improves the reliability of opening of the parachute, but also needs no daily maintenance. At the same time, the reel for the sling with coil spring and the tower-type parachute with more than two layers can debase effectively the pulling strength between the parachute and the airplane and provide enough cushion at the moment of the parachute opening, which makes it possible for the parachute-landing device for whole large airplane.

### FIELD OF THE INVENTION

The present invention relates to the field of the parachute-landing device, in particular, to a kind of parachute-landing device for whole airplane with fixed wings.

### BACKGROUND OF THE INVENTION

At present, people have made many attempts to guard the airplane in flight as well as the staff on it, such as the parachute-landing system for whole airplane designed by Cirrus Design Corporation of America, which is installed on their four-seats small planes and under which the tragedy of damage to the airplanes and the dead of people caused by the airplanes out of control is wished to be avoided.

The parachute-landing system for whole airplane comprises a parachute compartment set on the airplane, in which there set a parachute and a solid rocket fixed to the parachute, and the solid rocket is connected electrically with the emergency button in the pilot cabin through an ignition device which uses Mg as its media, and the sling of the parachute directly fixes on the wings and the body of the airplane. Then, when the airplane has any problem, the passengers can beat the emergency button and let the ignition device make the solid rocket start to work, and the solid rocket will destroy the cover on the surface of the parachute compartment and undress the parachute, as the ascending speed of the solid rocket exceeds the speed of the airplane, the parachute will be pulled out of the parachute bag and be opened, which can slow down the falling of the airplane.

However, that parachute-landing system for whole airplane has some shortcoming. First of all, the pop-up structure of the parachute is very complex which will make the cost high, and using the solid rocket as the power to open the parachute will reduce the reliability of the system; Secondly, the useful-life of the solid rocket is short which make it hard to reduce the cost of use and debase the reliability to open the parachute, and it will be harmful to people or objects on the ground as the remains splash down. Thirdly, there is a lack of enough cushion between the parachute and the airplane, which is easy to damage the airplane and the passengers on the airplane; Fourthly, the sling of the parachute is installed outside of the body of the airplane, which will effect the flown line and beauty of the airplane and increase the wind resistance of the airplane as well as the difficulty of the operation; Finally, there is only one parachute which has only one layer, of which the acreage is very limited and is not fit for larger airplanes, moreover, the pulling strength between the parachute and the airplane is quite strong at the moment of the parachute opening, and to the large airplane which has heavier body and larger parachute, the sling of the parachute may be broken or the body of the airplane may be slit under huge pulling strength.

### SUMMARY OF THE INVENTION

It is an object of the present invention to provide a parachute-landing device for whole airplane which can open the parachute effectively without power.

It is another object of the present invention to provide a parachute-landing device for whole airplane which can effectively debase the pulling strength between the parachute and the airplane at the moment of the parachute opening and provide enough cushion for the opening of the parachute.

It is one more object of the present invention to provide a parachute-landing device for whole airplane which can still effectively increase the acreage of the wind resistance of the parachute under the precondition of not increasing the acreage of the single parachute.

For achieving the object above, the parachute-landing device comprises at least one parachute compartment on the airplane, which has a cover who can be controlled to open, and in which there set a parachute with a guiding parachute which is set in the space formed by the parachute compartment and its cover, and the end of the sling of the parachute is fixed relatively to the parachute compartment, characterized in that a wind-guiding pipe is set on the windward side of the parachute compartment, the front end and the rear end of the wind-guiding pipe are respectively the air inlet and the air outlet, and the air inlet will be covered by the cover of the parachute compartment when the cover is closed, while the air outlet is located in the parachute compartment and the guiding parachute of the parachute covers the air outlet.

The device to control the cover of the parachute compartment to open can adopt any prior existing art, such as hydraulic pushrod controller, pneumatic pushrod controller, blowing-up controller. Simply, the device can comprise a retractable lock tongue set on the parachute compartment and a corresponding lock base set in the inner side of the cover of the parachute compartment which has a lock hole for the front end of the lock tongue to insert in when the cover is closed, and it maintain the cover be closed. While the cover is needed to be open, the lock tongue can be retracted and it will leave the lock hole of the lock base. Then, even if there is no other device to help the cover to be open, as the airplane is flying in high speed, according to the Bernoulli's Principle, the cover of the parachute compartment will also be open automatically under the effect of the air flow passing over the cover of the parachute compartment. At that time, the air flow in high speed will enter the air inlet of the wind-guiding pipe and go out from the air outlet, and it will make the guiding parachute which cover on the air outlet be swelled up and open, then the main body of the parachute will be pulled out and be fully opened.

Here, the lock tongue can be retracted by hand or by electromotion. If by hand, the rear end of the lock tongue can simply connect with a manual dragline, another end of the manual dragline is located in the pilot cabin. If by electromotion, the lock tongue can have a tractive magnet on its rear end which can magnetize the lock tongue to retract, that forms an electromagnetism lock. And the switch of the tractive magnet can also be installed in the pilot cabin. It can also adopt any prior existing art to make the lock tongue return forward, for example, setting another manual dragline or another tractive magnet on the front end of the lock tongue, or using pin simply. But in order to make the lock tongue return automatically, the lock tongue can have a flange near its front end and its rear end goes through the hole of a back seat for lock tongue which is fixed on the parachute compartment, a spring round the middle of the lock tongue, the front end of the spring leans against the flange of the lock tongue, and the rear end of the spring leans against the back seat for lock tongue. Under the effect of the spring, the lock tongue tends to extend forward all along.

In order to debase effectively the pulling strength between the parachute and the airplane and provide enough cushion at the moment of the parachute opening, the end of the sling of the parachute can adopt below mode to be fixed relatively to the parachute compartment: a reel seat and a reel for parachute sling are set in the parachute compartment, and the reel is rotatablely set on the reel seat, besides a coil spring is set between the reel seat and the reel with its two ends separately jointed on the reel seat and the reel, and the end of the sling of the parachute is fixed and coiled on the reel. Then, when the parachute is opening, the coil spring will have potential energy under the drawing of the sling, thereby, the pulling strength between the parachute and the airplane in high speed can be greatly debased and absorbed, and the counterforce which impact the body of the airplane can be also greatly reduced after the parachute is open.

And in order to make a further improvement of debasing the pulling strength between the parachute and the airplane at the moment of the parachute opening, the parachute can be a tower-type parachute that has more than two layers, and the parachute of each layer shares the unique sling of the parachute. Thereby, when the parachute is opening, every layer of the parachute will open one by one from top to bottom. And it can debase the strength of the parachute pulling the airplane, and increase the acreage of the wind resistance of the parachute greatly. It also takes full advantage of the upper space of the airplane, to solute the problem of the parachute for a large airplane which needs super acreage, and make it possible for the parachute-landing device for a large airplane.

The cover of the parachute compartment can be abandoned, that is the cover will leave the parachute compartment under the effect of the air flow after the cover opens. To make the cover repeat to be used, the rear edge of the cover of the parachute compartment which is far from the windward side can be connected on the body of the airplane by hinge.

In order to accelerate the opening of the cover of the parachute compartment, the cover of the parachute compartment can have a spring means on at least one edge of its inner side to make it open easily. The spring means can be helix spring or plate spring.

In order to make the parachute-landing device descend smoothly, there can be set more than one parachute compartment. The parachutes can be set such as on the wings of the airplane, on the head of the body of the airplane and/or the tail of the body of the airplane.

Compared with the prior art, this present invention make it possible for parachute to be opened without power just through a wind-guiding pipe which is installed in the parachute compartment by making use of the air flow during the flight. It not only improves the reliability of opening of the parachute, but also makes the cost much less as it needs no daily maintenance. At the same time, the reel for the sling with coil spring can debase effectively the pulling strength between the parachute and the airplane and provide enough cushion at the moment of the parachute opening. While the tower-type parachute with more than two layers can not only make a further improvement to debase the pulling strength between the parachute and the airplane at the moment of the parachute opening, but also increase the acreage of the wind resistance of the parachute under the precondition of not increasing the acreage of the single parachute availably, which makes it possible for the parachute-landing device for a large airplane.

### BRIEF DESCRIPTION OF THE DRAWINGS

FIG. 1 is a perspective view of the parachute-landing device for whole airplane of an embodiment of the present invention.

FIG. 2 is the part sectional view of top plan view of FIG. 1.

FIG. 3 is the part sectional view of A-A way of FIG. 2.

FIG. 4 is the part sectional view of B-B way of FIG. 2.

FIG. 5 is the part of top plan view of FIG. 1 when the cover of the parachute compartment is open and the parachute flies out of the parachute compartment.

### DETAILED DESCRIPTION OF THE INVENTION

To enable a further understanding of the innovative and technological content of the invention herein, refer to the detailed description of the invention and the accompanying drawings below:

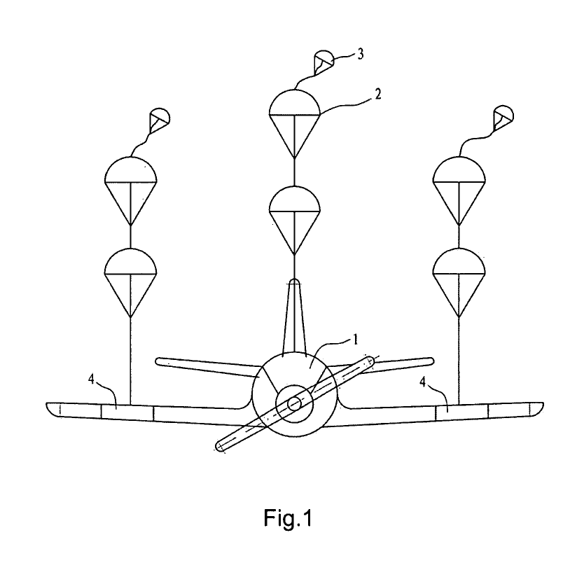

FIGS. 1˜5 show an embodiment of the present invention.

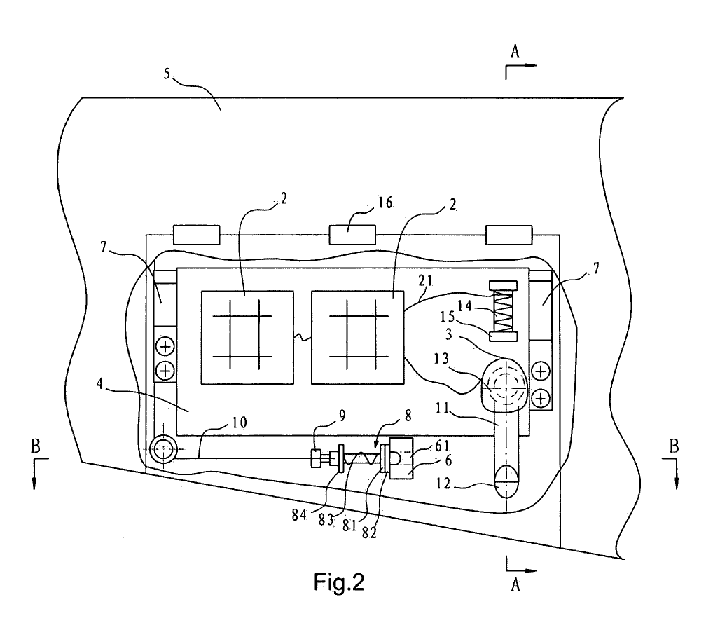

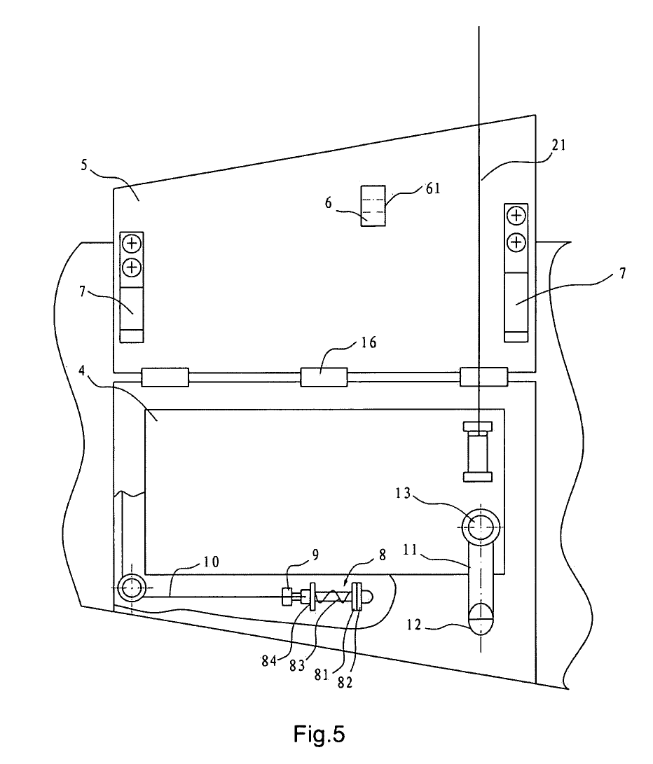

In this embodiment, three parachute compartments (4) are respectively on the two wings and the body of the airplane (1), every parachute compartment (4) has a cover (5) who can be controlled to open. The cover (5) is connected on the parachute compartment (4) through a hinge (16) set on the rear edge of the cover (5). A lock base (6) with a lock hole (61) is set in the inner side of the cover (5) of the parachute compartment (4). And two plate springs as spring means (7) to open the cover (5) are set on the two edges in the inner side of the parachute compartment (4), which connect with the parachute compartment (4) and resist it, as shown in FIG. 1, FIG. 2, and FIG. 5.

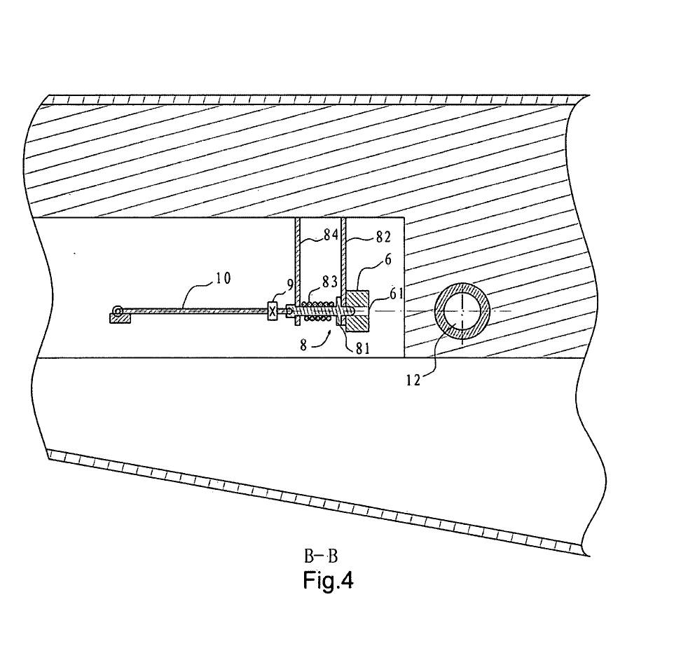

An electromagnetic lock is set at the front end of the parachute compartment (4) facing the direction that the airplane (1) marches. The electromagnetic lock is connected electrically with the switch installed in the pilot cabin. And the electromagnetic lock comprises a lock tongue (8) and a tractive magnet (9). The lock tongue (8) has a flange (81) near its front end, the front end of the lock tongue (8) in front of the flange (81) goes through the hole of a front seat (82) for lock tongue which is fixed on the parachute compartment (4) and inserts in the lock hole (61) of the lock base (6) on the cover (5) when the cover (5) is closed, while the rear end of the lock tongue (8) goes through the hole of a back seat (84) for lock tongue which is fixed on the parachute compartment (4) and connects with a manual dragline (10), the another end of the manual dragline (10) is also located in the pilot cabin. A spring (83) round the middle of the lock tongue (8), the front end of the spring (83) leans against the flange (81) of the lock tongue (8), and the rear end of the spring (83) leans against the back seat (84) for the lock tongue (8), as shown in FIG. 2, FIG. 4, FIG. 5.

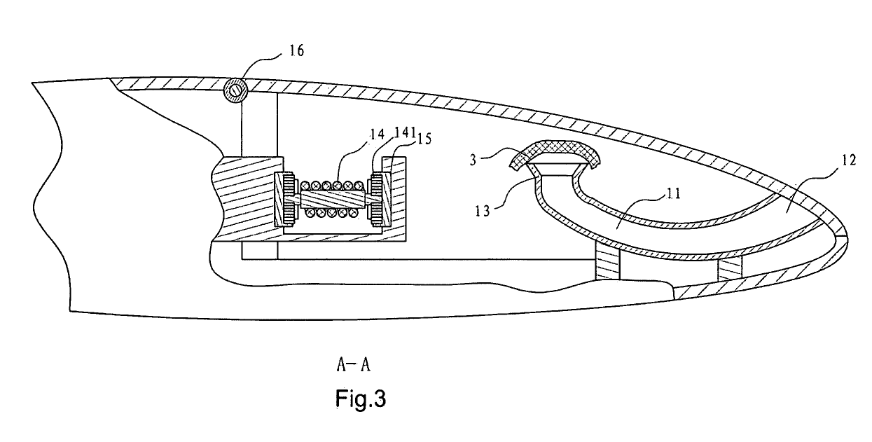

A wind-guiding pipe (11) is set beside the electromagnetic lock. The front end of the wind-guiding pipe (11) which face to the direction of the airplane marching is the air inlet (12), and the rear end of the wind-guiding pipe (11) is the air outlet (13), as shown in FIG. 2, FIG. 3, FIG. 4, FIG. 5.

While a reel seat (15) and a reel (14) for parachute sling are set in the parachute compartment (4), and the reel (14) is rotatablely set on the reel seat (15), besides a coil spring (14) is set between the reel seat (15) and the reel (14) with its two ends separately jointed on the reel seat (15) and the reel (14), as shown in FIG. 2, FIG. 3, FIG. 5.

In the parachute compartment (4), there set a parachute (2) which is a tower-type parachute who has three layers. The lower two layers of the parachute (2) are main parachutes, and the top layer is a guiding parachute (3) which covers on the air outlet (13) of the wind-guiding pipe (11). And the end of the sling (21) of the parachute (2) is fixed and coiled on the reel (14), as shown in FIG. 1, FIG. 2, and FIG. 3.

When using, during the normal flight of the airplane, the cover (5) of the parachute compartment covers hermetically on the parachute compartment under the cooperation of the lock tongue (8) of the electromagnetic lock, lock base (6) and the hinge (16), maintaining the streamline appearance of the airplane. When the airplane has malfunction, the pilot can only press the switch in pilot cabin, the tractive magnet (9) of the electromagnetic lock will magnetize the lock tongue (8) to retract and release the lock base (6) which is locked by the lock tongue (8). Then, the cover (5) will be open under the effect of the two plate springs which are acted as spring means (7), and will be open fully under the driving of the air flow in high speed facing to it. The air flow in high speed enter the wind-guiding pipe (11) from its air inlet (12), and blow up the guiding parachute (3) which covers on the air outlet (13), and make the guiding parachute (3) swell up and open. Immediately, the guiding parachute (3) will pull out the parachute (2) and open it under the driving of the air flow. Therefore, the airplane can be leaded and land slowly. While the huge pulling strength will be absorbed by the coil spring set between the reel seat (15) and the reel (14) for sling when the parachute (2) is opening. If there is no electricity or the switch cannot work when the airplane has malfunction, the pilot can only pull the manual dragline (10) by hand in the pilot cabin instead.

Apparently, the technician of this field can make various change and transmutation to the parachute-landing device for whole airplane of present invention without carrying out of the spirit and range of the present invention. Then, if these modification and transmutation belong to the claims of the present invention or is within the range of the equal technology, the present invention tends to include these change and transmutation.

1. A parachute-landing device for whole airplane comprising: at least one parachute compartment with a cover that can be controlled to open;
a parachute with a guiding parachute being set in the parachute compartment, the end of a sling of the parachute being fixed with the parachute compartment;
a wind-guiding pipe set on a windward side of the parachute compartment having an air inlet and air outlet located at the front end and rear end of the wind-guiding pipe respectively, the air inlet being covered by the cover when the parachute compartment being closed, the air outlet is located in the parachute compartment and covered by the guiding parachute of the parachute.

2. The parachute-landing device for whole airplane of claim 1, wherein a device for opening cover comprises a retractable lock tongue set on the parachute compartment and a lock base with a lock hole set in the inner side of the cover, when the cover is closed the front end of the lock tongue inserts into the lock hole.

3. The parachute-landing device for whole airplane of claim 2, wherein the rear end of the lock tongue is connected with a manual dragline having another end located in a pilot cabin.

4. The parachute-landing device for whole airplane of claim 3, wherein the lock tongue has a tractive magnet on its rear end to control lock or release for the lock tongue.

5. The parachute-landing device for whole airplane of claim 3, wherein the lock tongue has a flange near its front end, the rear end of the lock tongue goes through a hole of a back seat fixed on the parachute compartment, a spring is sleeved on the middle part of the lock tongue, the front end of the spring is against the flange of the lock tongue, and the rear end of the spring is against the back seat.

6. The parachute-landing device for whole airplane of claim 1, wherein a reel seat and a reel for parachute sling are set in the parachute compartment, the reel is rotatablely set on the reel seat, a coil spring is set between the reel seat and the reel with its two ends separately jointed with the reel seat and the reel, and the end of the sling of the parachute is fixed and coiled on the reel.

7. The parachute-landing device for whole airplane of the claim 1, wherein the parachute is a tower-type parachute having more than two layers and the parachute of each layer shares the sling of the parachute only.

8. The parachute-landing device for whole airplane of claim 1, wherein the rear edge of the cover far from the windward side is connected on the body of the airplane by a hinge.

9. The parachute-landing device for whole airplane of claim 8, wherein the cover has a spring means on at least one edge of the inner side of the cover for opening cover easily.

10. The parachute-landing device for whole airplane of claim 1, wherein there are more than one parachute compartment for one airplane.

11. The parachute-landing device for whole airplane of claim 4, wherein the lock tongue has a flange near its front end, the rear end of the lock tongue goes through a hole of a back seat fixed on the parachute compartment, a spring is sleeved on the middle part of the lock tongue, the front end of the spring is against the flange of the lock tongue, and the rear end of the spring is against the back seat.
